(19) United States
(12) Patent Application Publication
(10) Pub. No.: US 2026/0275625 A1
(43) Pub. Date: Sep. 17, 2026

(54) Method and Device for Separating a Textile Consisting of Plastic Fibers

(71) Applicant: Fraunhofer-Gesellschaft zur Férderung der angewandten Forschung Eingetragener Verein, München (DE)

(72) Inventor: Mathias Kott, Dresden (DE)

(21) Appl. No.: 19/148,341

(22) PCT Filed: Jan. 12, 2024
(86) PCT No.: PCT/DE2024/100027

§ 371 Date: Jul. 16, 2025

(30) Foreign Application Priority Data
Jan. 16, 2023 (DE) 10 2023 100 890.0

(51) Int. Cl. D06H 7/22; D06H 7/02

(52) U.S. Cl. CPC D06H 7/221; D06H 7/02

(57) ABSTRACT

The invention relates to a method and a device for the thermal separation of a textile (10) consisting of plastic fibres (9). According to the invention, an impact pulse acts on the textile (10), which is arranged in a single layer between a pair of unheated impact jaws (2, 4), such that the textile is separated and the separation edge (12) is formed, wherein the plastic of the fibres (9) melted during the impact pulse is limited to the region of the separation edge (12).

### CROSS REFERENCE TO RELATED APPLICATIONS

This application is the U.S. national stage of International Application No. PCT/DE2024/100027, filed on 2024 Jan. 12. The international application claims the priority of DE 102023100890.0 filed on 2023 Jan. 16; all applications are incorporated by reference herein in their entirety.

### BACKGROUND

The invention relates to a method and a device for the thermal separation of a textile consisting of plastic fibers. Textiles include, for example, woven fabrics, knitted fabrics, non-woven fabrics, ropes, cords, and threads, all made from meltable synthetic fibers. Known methods for processing flat material webs, such as the separation of films by means of an impact pulse using a film punch according to publication DE 10 2015 211 622 A1, are not suitable for separating textiles in such a way that a separation edge is formed, which protects the textile or the rope from fraying at the edge after separation. The publication JP S58-78 605 A offers a solution for textile separation by means of an impact pulse. The continuously produced tear line is divided into sections of the required length by individual impact pulses. However, a continuous, high-speed process is not described.

The impact device and process according to publication U.S. Pat. No. 4,747,455 A are capable of generating individual impacts. No continuous process is described.

### SUMMARY

The invention relates to a method and a device for thermally separating a textile (10) consisting of plastic fibers (9); according to the invention, an impact pulse acts on the textile (10) arranged in at least one layer between a pair of unheated impact elements (2, 4), so that the textile is separated and the separation edge (12) is formed, with the plastic of the plastic fibers (9) melted during the impact pulse being restricted to the area of the separation edge (12).

### DETAILED DESCRIPTION

It is therefore the object of the present invention to thermally separate textiles based on plastic fibers or consisting of plastic fibers, and to offer a robust, uncomplicated, and fast method for continuous application, while at the same time protecting the textile from fraying. A further object of the invention is to provide an energy-saving and simple device for separating textiles with the corresponding properties.

The object of the invention is solved by a method for the thermal separation of a textile based on plastic fibers or consisting of plastic fibers, wherein the plastic fiber must be meltable. The melting point must be below the temperature reached during the impact pulse.

An impact pulse, a stroke movement of at least one of the impact elements running perpendicular to the textile with a penetration time of at least one of the impact elements into the textile of less than 10 ms, is applied to the textile arranged in at least one layer between a pair of unheated impact elements. A pair of unheated impact elements is also present when an impact element works against an abutment, an anvil. The abutment or anvil then forms the second impact element of the pair. It is not necessary to heat the impact elements. On the contrary, this would be rather disadvantageous, especially if the heating, as an external heat supply, were to result in softening of the textiles. Thus, preheating of the textiles is also excluded. Therefore, “unheated” refers to a temperature of the impact elements and the textiles that remains below the softening temperature of the textiles. If, for other reasons, the impact elements or the textiles are slightly heated, this does not affect the method according to the invention, and the impact elements or the textiles are considered to be unheated or not preheated within the meaning of the invention.

According to the invention, opposing impact elements are used in a high-speed, continuous process. The method for thermal separation is preferably integrated into a high-speed, continuous process or a high-speed machine or system. This applies in particular to a continuous web-guiding process with continuous feed, for example, in a system for the production of technical textile products such as face masks. Such systems operate, for example, at 100 cycles per minute.

The separation edge on a textile consisting of plastic fibers, e.g., woven fabrics, knitted fabrics, nonwovens, or also ropes, cords, or threads, consists of plastic fibers fused together. It is produced by or during the thermal separation of the textile. Thermal separation is defined in such a way that the textile is first compressed or otherwise deformed at an effective point, whereby the heat required for separation, and in particular for the formation of the separation edge, is generated in the textile, and the resulting heat fuses the plastic fibers together.

For this purpose, an impact pulse is applied to the textile arranged in at least one layer between a pair of unheated impact elements. The effect of the impact pulse takes place between the unheated impact elements. In any case, it is not necessary to heat the impact elements; on the contrary, it is rather disadvantageous, especially if the heating, as an external heat supply, leads to premature softening of the textile and thereby impairs the generation of heat during forming. Thus, preheating of the textiles is also excluded. Therefore, “unheated” in the sense of the invention refers to a temperature of the impact elements and the textiles that remains below the softening temperature of the textile. If, for other reasons, the impact elements or the textiles are slightly heated, this does not affect the method according to the invention, and the impact elements or the textiles are regarded as unheated or not preheated within the meaning of the invention. A pair of unheated impact elements also exists if they are an unequal pair and one impact element acts against an abutment or an anvil, which then forms the second impact element of the pair.

The impact pulse is a stroke movement of at least one of the impact elements perpendicular to the textile layer with a penetration time of at least one of the impact elements into the textile that is shorter than 10 ms. In this case, the impact pulse, which is preferably generated by a mechanical drive, acts on the textile, causing the textile to be separated and the separation edge to be formed. This is achieved by directly fusing the separated plastic fibers of the textile with each other, since the material is reshaped with the development of heat during the separation process. The plastic fibers are thereby fixed, and unwanted disintegration of the textile from the edge, i.e., fraying, is prevented. The separation edge is formed by the impact pulse penetrating the textile, deforming it, and thereby briefly heating and melting its fibers, wherein the heating is limited to the immediate effective zone, the area of the separation edge.

The separation edge can be applied, for example, to a woven fabric, knitted fabric, warp-knitted fabric, or nonwoven, or the textile is a rope, a thread, or a cord. The plastic melted during the impact pulse is thereby directly limited to the area of the separation edge, whereas conventional melting processes, due to the lack of targeted heating, heat and melt a larger area. This leads to larger hardened areas and, in some cases, an unattractive appearance.

The direct restriction of the separation edge to a narrow area is particularly advantageous in the case of a woven fabric, knitted fabric, warp-knitted fabric, or nonwoven that is cut out as a ready-made part according to the invention and simultaneously edged by the separation edge. By limiting the separation edge to a minimum, unlike conventional melting processes, there is no hardened area that scratches a garment or impairs its visual appearance.

A far greater significance of the separation edge and, in this context, also of the process for its production lies in the field of technical textiles, for example, filter nonwovens or nonwovens for battery production. In the production of large quantities, shape-based processes are clearly advantageous over incremental processes such as laser cutting, with additional advantages of the invention being low energy consumption and simple, fail-safe system technology.

It has been shown that, in addition to cutting out, an embossing can be created in the textiles by the impact pulse, which is produced when the impact elements strike the textiles according to the contour of the impact elements. This effect can be used for further applications, such as for solidifying the material, for imprinting information, or for design purposes.

Solidification of a surface is carried out using a rather flat impact element. This can be applied, for example, to a wider edge to which other elements are attached, such as a rubber band on a filter mask. Joining, e.g., the rubber band, can also be carried out according to the invention by means of an impact pulse, wherein welding or the use of a meltable adhesive can be used. The brief heating required in each case is then also introduced into the material by the impact pulse and the resulting deformation.

By solidifying a surface, the edge of an eyelet can also be produced, and the required opening of the eyelet can be cut out beforehand or afterwards. The solidification then takes place similarly to the formation of the separation edge by melting as a result of one or more impact pulses. The application of the impact pulses can also be carried out selectively, in which case numerous solidified points arranged in a row lead to the desired surface. While a line-shaped punch is used for separation with formation of the separation edge, a rather flat shape is advantageous for melting to form a surface or for thermal joining.

Due to the rapid increase in temperature, the material temperature otherwise hardly has any influence, unless the material softens adversely. The same applies to the impact elements, which do not need to be preheated, because the temperature required for bonding is generated in the textile itself in a very short time during the pulse. Therefore, the heating and melting of the textile are advantageously limited to an immediate effective zone and a short contact time. Due to the high deformation speed, adiabatic heating of the textiles occurs in the effective zone with minimal energy input and without heat exchange with the surrounding air and the adjacent areas of the textiles. Only as much plastic fiber material is liquefied as is necessary for the formation of the separation edge by melting the fiber ends together. This also prevents liquid material from molten fibers from being pressed out of the joining area and unnecessarily thickening the separation area.

Preferably, the impact pulse is generated by a mechanical drive. When the impact pulse acts on the textile, it is separated at that point and a compression area and/or a separation edge is formed, followed by the return stroke of the at least one impact element. The impact pulse acts on the textile with at least a first intensity Fᵢ₁ in order to plastically compress the textile. If the impact pulse acts on the textile with a second intensity Fᵢ₂, the textile is separated between the impact elements and, depending on the contour of the impact element, compressed or at least partially melted separation edges made of melted plastic fibers remain on both sides of a separation line.

In addition, there is a saving of time and reduced energy input. Such a narrow heat-affected zone cannot be achieved with conventional methods for melting the edge or end of a textile, because the heat is dissipated too quickly and, as a result, the heated and softened area of the textiles would increase. It has been shown that the melting width during separation is limited to a range that does not exceed twice the thickness of the textile layers.

In the step preceding the impact pulse, the textiles are pressed against each other between the pair of impact elements with a pre-tensioning force Fᵥ. Thereafter, the impact pulse of at least one of the driven impact elements is applied, or the impact pulse is transmitted by at least one of the impact elements and ultimately acts on the textiles. Thus, as an alternative to a tool that falls directly onto the textiles, the textiles arranged one above the other are first pressed together. This partially compensates for the roughness of the tool surfaces and, above all, the textiles. In all cases, a temperature effect arises in the effective zone where the separation edge is formed, resulting in local heating. During the penetration time and due to the mechanical stress occurring as the impact pulse penetrates at a correspondingly high deformation speed, this leads to a very brief melting of the plastic from which the plastic fibers are made. It has proven advantageous if, in the step preceding the impact pulse, the textile is subjected to a pre-tensioning force Fᵥ, preferably by means of at least one pre-tensioning roller, and thereafter, the impact pulse of at least one of the driven impact elements acts on the textile. In order to carry out the process continuously in this manner, the pre-tensioning device is designed as a rotating pre-tensioning roller under which the web can move.

At least one driven impact element can be moved within the pre-tensioning roller and executes the impact pulse whenever it is aligned perpendicularly with the textile.

According to an alternative embodiment, the impact pulse, generated by at least one of the driven impact elements, acts indirectly on the textile, being transmitted via at least one pre-tensioning roller. For this purpose, the impact pulse is first applied by at least one impact element to at least one pre-tensioning roller. Given that at least one of the impact elements initially applies the impact pulse to the pre-tensioning roller, the pre-tensioning roller is designed to transmit the impact pulse. The impact pulse is indirectly introduced into the textile via the pre-tensioning roller. For this purpose, the pre-tensioning roller may have a suitable profile on its circumferential surface or such a diameter as to allow the application of the impact pulse with the appropriate contour and intensity.

According to a further alternative, the impact drive may also act on the pre-tensioning roller or on an additional, correspondingly profiled roller. In this case, it serves solely as an impact element. An additional impact element can then be omitted.

The melting remains limited to the effective zone. As a result, neither the environment is affected by undesirable heat input (e.g., the area around the separation edge in the textile burns, as with conventional melting methods), nor does heat dissipate to the environment as energy loss.

The impact pulse is preferably generated by a mechanical or magnetic drive, whereby the mechanical drive of the impact elements is direct, or the impact pulse is transmitted indirectly by spring force, a drop weight, a magnetic drive, or a cam gear. With the cam gear, particularly fast movements can be controlled without delay and with precise amplitude. In particular, the spring force and the drop weight can be manually brought into the position where they generate force, so that the method according to the invention can be carried out without an external energy supply.

A pair of unheated impact elements also exists if they are an unequal pair and one impact element acts against a passive, flat abutment, which then forms the second impact element of the pair. The impact pulse is a stroke movement of at least one of the impact elements, running essentially perpendicular to the textiles, with a penetration time of at least one of the impact elements into the textiles of less than 10 ms. Preferably, the penetration time is less than 5 ms, particularly preferably less than 1 ms, depending on the thickness of the textile. To generate the impact pulse, either the tool plunges onto the textiles, preferably at a speed of 1 to 5 m/s as the starting speed, and is braked to a standstill during the penetration time. The impact pulse is preferably generated by a mechanical drive, alternatively by an electric magnetic drive. The impact pulse is applied by the upper impact element or, alternatively, by both opposing impact elements. Particularly in the case of opposing impact elements, these are used for the high-speed, continuous process or the high-speed machine or system, in particular a continuous web-guiding process with continuous feed, for example in a system for manufacturing technical textile products such as face masks, which operates at 100 cycles per minute, for example, and are integrated into this. The impact elements can be designed as rollers, which can also function as feed rollers, for example, that apply the pre-tensioning force Fᵥ, while the pulse force Fi is transferred to the textiles by an impact on the rollers.

The object of the invention is also solved by a device for separating a textile consisting of plastic fibers by thermal separation. According to the invention, thermal separation is defined in such a way that the textile is first compressed or otherwise deformed by the penetrating effective area of the impact element, whereby the heat required for separation, in particular for forming the separation edge, is generated in the textile and the plastic fibers fuse together.

For this purpose, the device comprises a pair of unheated impact elements, between which the textile is arranged in at least one layer during the separation process; a device for pulse generation introduces an impact pulse into at least one of the impact elements during the thermal separation, which then acts on the textile, separating it at a separation point and forming a separation edge on both sides of the separation point. A pair of unheated impact elements also exists if one impact element works against an abutment, a flat anvil, which then forms the second impact element of the pair. The device for pulse generation is designed to introduce an impact pulse into at least one of the impact elements. The impact pulse is a stroke movement of at least one of the impact elements perpendicular to the textile layer, which has a penetration time into the textiles and into the textile of less than 10 ms. The impact pulse acts on the textiles and, by melting the plastic fibers at the edge of the textile, forms a separation edge in the effective area of the impact elements. The impact pulse is preferably generated by a drive device.

According to the invention, the first and/or the second impact element is designed to act in a high-speed, continuous process, in particular a web-guiding process with continuous feed, as described above for the method according to the invention.

According to an advantageous embodiment of the method and device, the first and/or second impact element is designed as a rolling tool to act in a web-guiding process with continuous feed. Alternatively, the first and/or second impact element is designed as a tool that swivels toward the effective point or as a tool that is temporarily carried along with the web during the separation or embossing process, as is customary and generally known in web-guiding processes for certain processing stages, so that the impact pulse can be applied while the web is running. The carried-along tool may consist of otherwise stationary impact elements, but they are guided at web speed during the impact pulse and are then returned more quickly to the starting position.

The device according to the invention is therefore suitable for installation in complex systems, whereby established technology for separation can also be replaced. It is advantageous if the pair of impact elements is made of hardened steel with a ground surface. In addition, each impact element contains elements for attachment to the drive device.

According to an advantageous further development, a device for applying a pre-tensioning force Fᵥis provided, by means of which the impact elements are pressed against each other by the pre-tensioning force Fᵥbefore the impact pulse is applied. In the preferred embodiment, the pair of impact elements comprises at least a first impact element with an effective area having a profiled cross-section. It has also proven to be advantageous when the pair of impact elements includes the second impact element with a wedge-shaped effective area. An advantageous profiled cross-section has a wedge profile bounded by two radii R2 with any contour shape and a width a that covers at least the effective zone-separation edge. According to a first alternative, the profiled cross-section is formed as a radius R1. According to a second alternative, the profiled cross-section is wedge-shaped with an angle a against the flat effective area of the second impact element, the wedge tip of which is formed as a radius R3. In general, regardless of the configuration of the profiled cross-section, the main profile, it is advantageous if it is bounded by radii in order to prevent undesired kinking of the textile at the edge of the profile. It has also proven to be advantageous if the pair of impact elements includes a second, usually lower impact element with a flat effective area or with a profiled cross-section.

According to a first embodiment, the drive device acts on the first impact element, or according to a second embodiment, on the first and second impact elements. The drive device for generating the impact pulse comprises a spring, a drop weight, or a mechanical gear. According to an advantageous embodiment, the mechanical gear is a cam gear, the advantages of which have already been explained above. A magnetic drive is also provided, which directly drives the impact element or the associated punch.

Compared with the established separation processes, the sealing process proposed by the invention offers the following advantages:
very cost-effective and robust system and tool technology;
purely mechanical and manually operated solutions can be implemented (spring pre-tensioning);
extremely short process time;
specific separation and embossing patterns can be achieved by using profile patterns on the tools;
very low energy requirement, resulting in very high energy efficiency;
advantageous as a shape-based process, because it is faster than incremental processes (such as laser) for large quantities.

The above advantages result in advantageous areas of application in the following:
use in continuous processes due to high process speed;
applications for separating without electrical energy by means of spring pre-tensioning for mobile use;
technical textiles, e.g., filter nonwovens and nonwovens for battery production.

### BRIEF DESCRIPTION OF THE DRAWINGS

The invention is explained in more detail below on the basis of the description of embodiments and their illustration in the associated drawings. The drawings show:

FIG. 1: a schematic view of a process sequence of the method according to the invention for separating textiles;

FIG. 2: schematic perspective views of three embodiments of an impact element according to the invention with different effective areas;

FIG. 3: schematic perspective view of an embodiment of a first impact element according to the invention with an effective area with a flat profiled cross-section;

FIG. 4: schematic perspective view of an embodiment of a second impact element according to the invention with a flat effective area;

FIG. 5: schematic side view of an embodiment of a continuous web-guiding process;

FIG. 6: schematic side view of a further embodiment of a continuous web-guiding process;

FIG. 7: schematic view of an embodiment of a device according to the invention with separated textiles;

FIG. 8: schematic enlarged view of a separated textile with separation edge;

FIG. 9: schematic enlarged view of a plastic fiber of a separated textile with separation edge; and

FIG. 10: schematic enlarged view of a plastic fiber of a textile with a compressed effective zone.

### DETAILED DESCRIPTION OF THE PREFERRED EMBODIMENTS

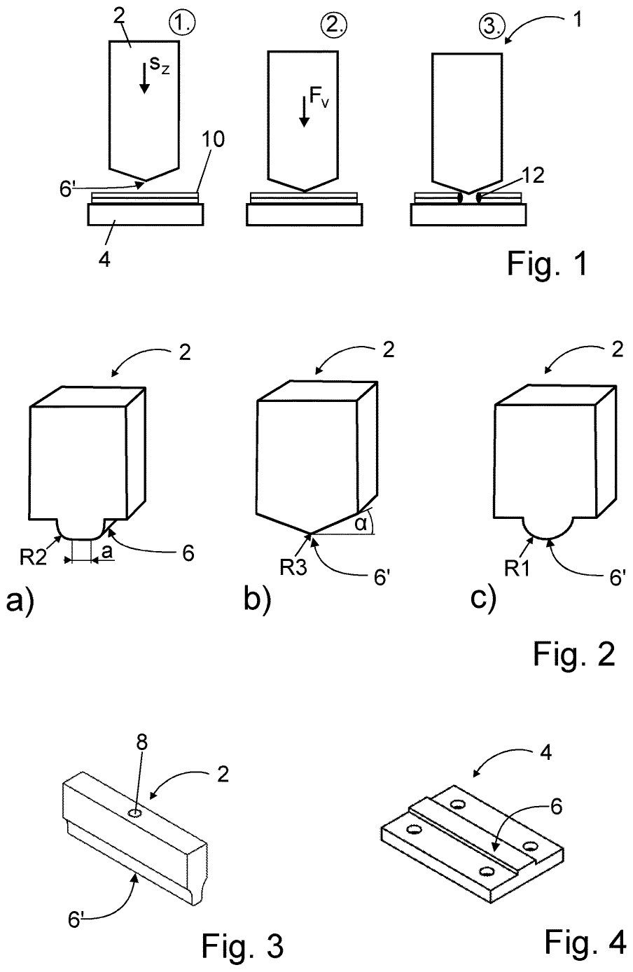

FIG. 1 shows a schematic view of an embodiment of a process sequence of the method according to the invention for separating textiles 10, which are inserted in double layers into device 1, using an impact pulse. The process sequence is shown in three steps, starting from the left. First, in a first step, a first impact element 2 is moved along the infeed path s_{z} to the surface of textiles 10 in the direction of the arrow until an effective profile 6′ touches textiles 10. The two textiles 10 to be separated, which should also receive a separation edge 12, rest on the surface of the second impact element 4, here designed as a flat anvil. The effective profile 6′ of the first impact element 2 is wedge-shaped.

In a second step, the first impact element 2 is pressed against textiles 10 with pre-tensioning force Fᵥ. Under the preload thus created, which compensates for the roughness and elasticity of textiles 10, in the third step, the pulse force Fi is applied to separate textiles 10, which briefly melt in the process, which also leads to the formation of separation edge 12.

The described process sequence is repeated in rapid succession when used in a high-speed, continuous process, as provided by the invention.

FIG. 2 schematically shows in views a), b), and c) three perspective views of respective embodiments of impact element 2 according to the invention, each with a differently profiled cross-section. In view a), a flat cross-section with a flat working area, bounded by two radii R2, can be seen. In an exemplary effective profile 6, the preferred radius R2 is 1 to 4 mm, and the flat profile has a width a=0.1 to 0.5 mm. Such and similar, in particular wider, profiles are primarily used for compression.

In view b), the cross-section is wedge-shaped, particularly suitable for separation, and forms an effective profile 6, as used in FIG. 1. In view c), the cross-section is designed as a radius and is likewise suitable for separation, although the separation edge 12 is compressed and is overall wider.

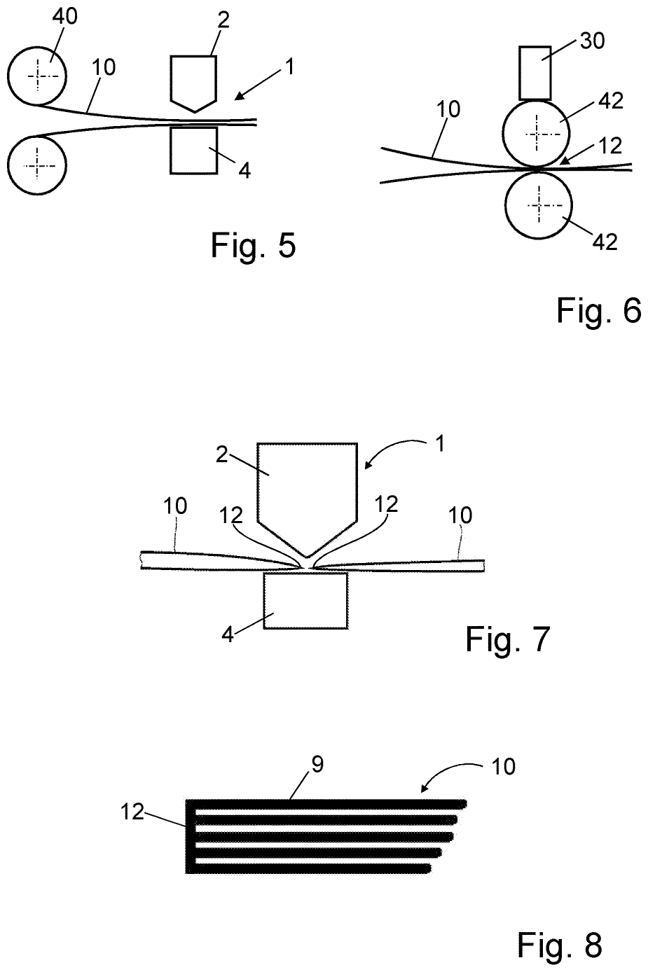

FIG. 3 schematically shows a perspective view of an embodiment of a first impact element 2 according to the invention with an effective area 6 with a flat profiled cross-section, as shown in detail in FIG. 2. A mounting opening 8 is provided for inserting a clamping bolt (not shown here), with which the first impact element 2 is fastened in an impact element holder 26 (see FIG. 5) of a machine that applies the pre-tensioning force Fᵥand the pulse force Fi to the first impact element 2.

FIG. 4 schematically shows a perspective view of an embodiment of a second impact element 4 according to the invention with a flat, anvil-like effective area. The second impact element 4 is attached to the impact element holder 28.

FIG. 5 shows a schematic side view of an embodiment of a continuous web-guiding process, in which textiles 10 run from two web rollers 40 and are supplied to device 1 in two layers. In device 1 for separating textiles 10, textile 10 runs in two layers between the first impact element 2 and the second impact element 4, where the separation and formation of the separation edge 12 take place (in the illustration, the separation edge 12 has not yet been formed and the separation is still pending). However, precautions must be taken to ensure the continuity of the web-guiding process, even during the application of the pre-tensioning force, in particular, and the impact pulse. This can be realized, for example, by cyclically moving and returning device 1 in and against the web-guiding direction or by using a web accumulator after the web rollers 40 and before device 1 (both not shown, but known from the state of the art).

FIG. 6 shows a schematic side view of another embodiment of the continuous web-guiding process. The pre-tensioning force is applied by pre-tensioning rollers 42 between which the textiles 10 run in two webs. A device for pulse generation 30, in particular an impact gear, acts on one or both pre-tensioning rollers 42, so that textiles 10 are separated and a separation edge 12 remains at the separation point.

FIG. 7 schematically shows a side view of an embodiment of device 1 according to the invention during the separation of textiles 10, with a separation edge 12 formed at the same time. This is particularly clear in the enlarged illustration in FIG. 8. Device 1 comprises impact elements 2, 4, which are shown after the return stroke, which releases the separated textiles 10 with the separation edge 12 on both remaining parts of textiles 10 after separation.

FIG. 8 schematically shows an enlarged view of a separated textile 10 with a separation edge 12. It shows how the plastic fibers 9 are melted together and thus form the separation edge 12. Above all, this ensures that textile 10 remains protected from undesired dissolution even after separation, and individual plastic fibers 9 are prevented from detaching. Examples include woven, knitted, or non-woven fabrics, where the separation edge can replace a hem. In other examples of the application of the method according to the invention, the textile is a rope, a thread, or a cord, and the separation edge forms an end that is secured against fraying. Without such protection, plastic fibers 9 can detach from the edge after cutting without further measures, and textile 10 gradually falls apart.

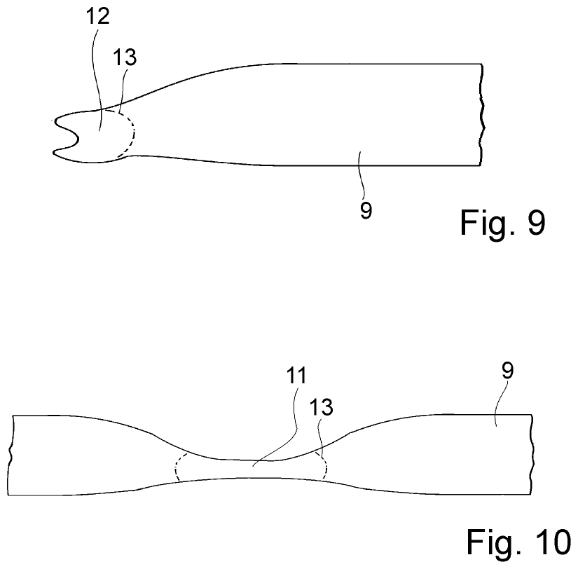

FIG. 9 schematically shows an enlarged view of a plastic fiber 9 belonging to a separated textile 10 with a separation edge 12. A heat-affected area 13 is indicated by a dashed line. This shows that the heat generated in the material by the impact pulse is limited to the separation edge 12.

FIG. 10 schematically shows an enlarged view of a compressed effective point, a compression area 11 of plastic fiber 9. Textile material 10 is formed from a plurality of plastic fibers 9. The area of plastic fiber 9 next to the compression area 11 does not appear thickened, as is the case, for example, in other thermal separation or welding methods according to the prior art, where liquid plastic material is pressed out of a melted area. This clearly shows that no excess plastic material is melted and displaced. Rather, the heat-affected area 13, whose boundary with the unaffected areas of plastic fiber 9 is shown by a dashed line, is limited to the area of the compressed joint 14. Neither the plastic fiber 9 nor any area outside it is affected by undesirable heating.

### LIST OF REFERENCE NUMERALS

1 Device
2 First impact element
4 Second impact element
6, 6′ Effective range and effective profile
8 Mounting opening
9 Plastic fiber
10 Textile, textiles, textile materials
11 Compression area
12 Separation edge
13 Heat-affected area
20 Impact press
22 Stand
24 Operating lever
26 First impact element holder
28 Second impact element holder
30 (Device for) pulse generation
32 Feed device
40 Web roller
42 Rolling tool, pre-tensioning roller
a Effective profile width
R1 First effective profile radius
R2 Second effective profile radius
R3 Third effective-profile radius
Fᵥ Pre-tensioning force
Fi Pulse force and intensity of impact pulse
S_{z} Infeed path

1. A method for thermally separating a textile (10) consisting of plastic fibers (9), wherein an impact pulse, a stroke movement of at least one of the impact elements (2, 4) extending perpendicularly to the textile (10) with a penetration time of at least one of the impact elements (2, 4) into the textile (10) of less than 10 ms, acts on the textile (10) arranged in at least one layer between a pair of unheated impact elements (2, 4), whereby the textile (10) is separated between the impact elements (2, 4) and a separation edge (12) of bonded plastic fibers (9) is formed; characterized in that the opposing impact elements (2, 4) are used in a high-speed, continuous process.

2. The method according to claim 1, wherein the first and/or the second impact element (2, 4) is configured as a rolling tool (42) and the rolling tool (42) moves along in a web-guiding process with continuous feed.

3. The method according to claim 1, wherein the first and/or the second impact element (2, 4) is configured as a tool that pivots toward the effective point and acts in a web-guiding process with continuous feed.

4. The method according to claim 1, wherein the first and/or the second impact element (2, 4) is configured as a tool carried along with the web during the separation process and acts in a web-guiding process with continuous feed.

5. The method according to claim 1, wherein in a step preceding the impact pulse, the textile (10) is subjected to a pre-tensioning force Fy by means of at least one pre-tensioning roller (42) and then the impact pulse of at least one of the driven impact elements (2, 4) acts on the textile (10).

6. The method according to claim 2, wherein the impact pulse transmitted by at least one of the driven impact elements (2, 4) via at least one pre-tensioning roller (42) acts on the textile (10), wherein at least one impact element (2, 4) initially applies the impact pulse to at least one pre-tensioning roller (42) for transfer to the textile (10).

7. The method according to claim 1, wherein the mechanical drive that generates the impact pulse is provided by spring force, a drop weight, a magnetic drive, or a cam gear.

8. The method according to claim 1, wherein the impact pulse is applied by the upper impact element (2) alone or by both opposing impact elements (2, 4).

9. A device for thermally separating a textile (10) consisting of plastic fibers (9), wherein the device (1) comprises a pair of unheated impact elements (2, 4) between which the textile (10) is arranged in at least one layer during the separation process, and further comprises a device for generating a pulse (30), which is configured to introduce an impact pulse into at least one of the impact elements (2, 4);
characterized in that the first and/or the second impact element (2, 4) are configured and arranged to act in a high-speed, continuous process.

10. The device according to claim 9, wherein the first and/or the second impact element (2, 4) is configured, according to a first embodiment, as a rolling tool (42), according to a second embodiment as a tool pivoting toward the effective point, or according to a third embodiment as a tool carried along with the web during the separation process.

11. The device according to claim 9 or 10, wherein a pre-tensioning device is included, which applies a pre-tensioning force (Fᵥ) and presses the impact elements (2, 4) against each other by means of the pre-tensioning force (Fᵥ) before the impact pulse.

12. The device according to claim 11, wherein the pre-tensioning device is configured as a pre-tensioning roller (42).

13. The device according to claim 12, wherein at least one of the impact elements (2, 4) applies the impact pulse to the pre-tensioning roller (42) and the pre-tensioning roller (42) is configured to transmit the impact pulse, wherein the impact pulse is introduced into the textile (10) by the pre-tensioning roller (42).

14. The device according claim 9, wherein the pair of impact elements (2, 4) comprises at least a first impact element (2) with an effective area having a profiled cross-section (6′).

15. The device according to claim 14, wherein the profiled cross-section (6′) is designed as a radius R1.

16. The device according to claim wherein the profiled cross-section (6′) is wedge-shaped with an angle a against the flat effective area of the second impact element (4), the wedge tip of which is designed as radius R3.

17. The device according to claim 9, wherein the pair of impact elements (2, 4) comprises a second impact element (4) with a flat effective area (6) or with a profiled cross-section (6′).

18. The device according to claim 9, wherein the pulse-generating device (30) is configured to act on only one impact element (2, 4) alone or on both the first and the second impact element (2, 4) simultaneously.

19. The device according to claim 9, wherein the pulse-generating device (30) comprises a spring, a drop weight, or a mechanical gear.
